(19) United States
(12) Patent Application Publication
(10) Pub. No.: US 2005/0174374 A1
(43) Pub. Date: Aug. 11, 2005

(54) Image recording apparatus

(75) Inventors: Toshiyuki Ebihara, Hino-shi (JP); Seiji Tatsuta, Hachioji-shi (JP); Ken Ioka, Hachioji-shi (JP); Yasuhiro Komiya, Hino-shi (JP)

Correspondence Address: FRISHAUF, HOLTZ, GOODMAN & CHICK, PC, 220 5TH AVE FL 16, NEW YORK, NY, 10001-7708, US

(73) Assignee: Olympus Corporation, Tokyo (JP)

(21) Appl. No.: 10/508,380

(22) PCT Filed: Mar. 27, 2003
(86) PCT No.: PCT/JP03/03849

(30) Foreign Application Priority Data
Mar. 28, 2002 (JP) 2002-91938

(51) Int. Cl. B41J 2/07; B41J 2/355; B41J 2/345; B41J 2/155

(52) U.S. Cl. 347/13; 347/181; 347/211; 347/19

(57) ABSTRACT

An image recording device comprises: a first and second recording heads (11, 12) formed of recording elements cyclically arrayed, which are continuously arrayed with an overlapped region; image data distributing means (2) for distributing image data to these recording heads (11, 12); image data distribution region variation means (3) for setting an image data distribution region where the image data of each pixel is distributed to both the recording heads (11, 12) by the image data distributing means 2; correction parameter storage means (5) for storing a correction parameter for correcting the difference in the image density properties between the image data distribution region and the other region due to phase difference between the recording heads (11, 12); and image data correcting means (4) for correcting the image data in the image data distribution region based upon the correction parameter.

### TECHNICAL FIELD

The present invention relates to an image recording device, and particularly to an image recording device for recording in units of a line an image formed of pixels based upon image data.

### BACKGROUND ART

In many cases, conventional image recording devices such as printers, facsimiles, and so forth, include a recording head such as a thermal head, an ink-jet head, and so forth, formed of a plurality of recording elements.

Specifically, such a recording head has a configuration wherein the recording elements are arrayed in the direction orthogonal to the recording-sheet feeding direction for recording an image in units of a line.

Accordingly, the arrangement needs to employ a recording head formed of the recording elements thus arrayed with a width equal to or greater than the recording width in the line direction. However, such recording heads with a great length have poor yield in manufacturing, leading to a problem of high costs.

Accordingly, in the conventional technique, an arrangement has been available wherein a recording head with a small recording width which can be manufactured at low costs is employed, and an image is recorded with a great recording width while shifting and reciprocating the recording head a certain number of times.

However, with such an arrangement according to the conventional technique, long time is required for printing a single image. Accordingly, in the conventional technique, an arrangement has been further proposed wherein the plurality of recording heads with a small recording width are arrayed in the line direction so as to maintain a long recording width in the line direction, thereby improving printing speed as well as reducing costs.

With the arrangement wherein a single recording head with a small width is reciprocated, and the arrangement wherein a plurality of recording heads with a small width are arrayed, according to the conventional technique, a single image with a great recording width is formed of a plurality of partial images with a small recording width, and accordingly, a method for making irregularities around the boundary between the partial images less conspicuous is important.

As an example of the method for making irregularities around the boundary therebetween less conspicuous, an image processing device disclosed in Japanese Unexamined Patent Application Publication No. 6-38628 is known, wherein parts of recording area are overlapped by a plurality of recording elements, and in the first recording step, each overlapped part is recorded by the corresponding plurality of recording elements with a recording weighting factor gradually decreasing along the direction from the start to the end of the overlapped part, and in the second recording step, each overlapped part is recorded by the plurality of recording elements with a recording weighting factor gradually increasing along the direction from the start to the end of the overlapped part.

Furthermore, as another example of the method, an image processing device disclosed in U.S. Pat. No. 6,386,668, is known, wherein the arrangement includes the plurality of recording heads arrayed in order to extend the recording width, and corrects the irregularities in the image density which may occur around the boundary between the printing areas printed by the recording heads adjacent one to another, thereby obtaining the uniformity of the image-density property.

As described above, the recording head includes an array formed of a plurality of recording elements, and in general, the recording elements are formed with a fine size, and are arrayed at fine intervals. Accordingly, formation of a single recording-head array of the plurality of recording heads with generally used precision leads to deviation (phase deviation) between arrays of the recording elements of the recording heads adjacent one to another.

Such phase deviation often leads to irregularities in the image density around the boundary between the partial images adjacent one to another recorded by the recording heads adjacent one to another. However, the arrangements according to the conventional technique provide no countermeasure for solving the problems.

On the other hand, an arrangement may be made wherein the recording heads are arrayed with high precision of mounting. However, this leads to increased manufacturing costs, resulting in reduced advantages of low costs in employing the plurality of recording heads with a small recording width. Furthermore, even with an arrangement wherein the recording heads are arrayed with sufficiently high precision of mounting, deviation of the mounting positions may occur during operation of the recording device. Furthermore, in some cases, the recording heads need to be replaced, which cannot be handled by this arrangement.

The present invention has been made in order to solve the problems, and it is an object thereof to provide an image recording device for obtaining a high-quality image while suppressing irregularities in image density around the boundary between the partial images due to phase deviation between arrays of recording elements of the recording heads adjacent one to another.

### DISCLOSURE OF INVENTION

An image recording device for recording an image formed of pixels, in units of a line based upon image data, according to a first invention comprising: a plurality of recording heads formed of a plurality of recording elements cyclically arrayed along the line direction, which are continuously arrayed adjacent one to another in the line direction with head-overlapped regions included in array regions formed of the recording elements arrayed along the line direction; image data distributing means for distributing the image data to the plurality of recording heads; image data distribution region setting means for setting in the head-overlapped regions an image data distribution region formed of a series of one or more recording elements by the image data distribution means, the image data distribution region constituting a region where the image data of each pixel, is distributed to both of the two recording heads arrayed adjacent one to another; correction parameter storage means for storing a correction parameter corresponding to phase deviation between the cyclic arrays each of which are included in the two recording heads arrayed adjacent one to another, for correcting difference, which can be generated when there is the phase deviation, in recording image density properties between the recording elements included in the image data distribution region and the recording elements not included in the image data distribution region; and image data correcting means for correcting image data for the image data distribution region based upon the correction parameter stored in the correction parameter storage means.

Furthermore, with an image recording device according to a second invention, the image data distribution region setting means according to the first invention sets a data-overlapped region, wherein the image data of each pixel can be distributed to both of the two recording heads arrayed adjacent one to another, within the head-overlapped region, and sets for each line a position of the image data distribution region so as to be deviated to the line direction within the data-overlapped region.

Furthermore, with an image recording device according to a third invention, the three or more recording heads according to the second invention may be included, with all the data-overlapped regions included in the two or more head-overlapped regions being determined substantially with the same length along the line direction.

Furthermore, with an image recording device according to a fourth invention, the image data distributing means according to the first invention distribute image data with a distribution ratio for each pixel gradually changed from one side to the other side of the array of the recording elements forming the image data distribution region.

Furthermore, with an image recording device according to a fifth invention, the plurality of recording heads and the correction parameter storage means according to the first invention form a single unit, which allows the user to replace the recording heads without separating one from another.

Furthermore, with an image recording device according to a sixth invention, the image recording device according to the first invention further includes head position detecting means for measuring the positional relation between the recording elements included in the data-overlapped region so as to obtain the phase deviation.

Furthermore, with an image recording device according to a seventh invention, the image recording device according to the first invention further includes: test-pattern creating means for creating a test pattern for measuring the state of the array of the recording elements included in the recording head; and head position detecting means for measuring the positional relation between the pixels recorded by the recording elements included in the data-overlapped region in an image recorded based upon the test pattern created by the test-pattern creating means so as to obtain the phase deviation.

Furthermore, with an image recording device according to an eighth invention, the image recording device according to the sixth or seventh invention further includes head position detection instructing means for instructing the head position detecting means to detect the phase deviation at appropriate timing, with the correction parameter storage means storing the correction parameter corresponding to the new phase deviation at the time of the new phase deviation being obtained.

Furthermore, with an image recording device according to a ninth invention, the timing according to the eighth invention is a timing wherein the user adjusts at least one mounting position of the plurality of recording heads.

Furthermore, with an image recording device according to a tenth invention, the timing according to the eighth invention is a timing wherein non-operating time of the image recording device reaches a predetermined period of time from a point of previous timing when there is the previous timing, or a timing wherein non-operating time of the image recording device accumulated from the point of manufacturing reaches a predetermined period of time when there is not the previous timing.

Furthermore, with an image recording device according to an eleventh invention, the timing according to the eighth invention is a timing wherein operating time of the image recording device reaches a predetermined period of time from a point of previous timing when there is the previous timing, or a timing wherein operating time of the image recording device accumulated from the point of manufacturing reaches a predetermined period of time when there is not the previous timing.

Furthermore, with an image recording device according to a twelfth invention, the timing according to the eighth invention is once every predetermined time.

Furthermore, with an image recording device according to a thirteenth invention, the timing according to the eighth invention is a timing wherein the user turns on the power supply of the image recording device.

Furthermore, with an image recording device according to a fourteenth invention, the timing according to the eighth invention is a timing wherein change in the temperature of the recording head exhibits a predetermined value within a predetermined period of time.

Furthermore, with an image recording device according to a fifteenth invention, the timing according to the eighth invention is a timing wherein the temperature of the recording head reaches a predetermined temperature.

Furthermore, with an image recording device according to a sixteenth invention, the image recording device according to the eighth invention further includes a deviation detection sensor mounted on the recording head for detecting deviation of the recording head, with the timing is a timing wherein the deviation detection sensor detects deviation of the recording head equal to or greater than a predetermined value.

Furthermore, with an image recording device according to a seventeenth invention, the image recording device according to the eighth invention further includes an acceleration sensor mounted on the recording head for detecting at least whether or not acceleration equal to or greater than a predetermined value is applied to the recording head, with the timing being a timing wherein the acceleration sensor detects acceleration equal to or greater than the predetermined value.

Furthermore, with an image recording device according to an eighteenth invention, the image recording device according to the eighth invention further includes an acceleration sensor mounted on the recording head for detecting acceleration applied to the recording head, with the timing being a timing wherein the accumulated value detected by the acceleration sensor reaches a predetermined value from the point of previous measurement, otherwise, from the point of manufacturing.

Furthermore, with an image recording device according to a nineteenth invention, the image data correcting means according to the first invention corrects a quantization error occurred in correction of image data of at least one pixel in the image data distribution region when correcting image data of other pixels in the neighborhood.

### BRIEF DESCRIPTION OF THE DRAWINGS

FIG. 1 is a block diagram which shows a configuration of an image recording device according to an embodiment of the present invention.

FIG. 2 is a diagram which shows layout example of a recording head as to a recording paper sheet according to the embodiment.

FIG. 3 is a diagram which shows image data distributed by an image data distributing means according to the embodiment.

FIG. 4 is a diagram which shows the positional relation in a head-overlapped region between a first recording head and a second recording head according to the embodiment.

FIG. 5 is a diagram which shows the positional relation between the recording heads mounted with the phase deviation δ of 0.5 and 1.5 according to the embodiment.

FIG. 6 is a schematic diagram for describing the image density properties in the head-overlapped region where the image data is recorded by both the adjacent recording heads, which change due to the phase deviation δ according to the embodiment.

FIG. 7 is a diagram which shows distribution of the image data in the data-overlapped region according to the embodiment.

FIG. 8 is a diagram which shows distribution of the image data corresponding to setting of the image data distribution region according to the embodiment.

FIG. 9 is a diagram which shows an example of a curve of the correction parameter F(δ) in the form of a function according to the embodiment.

FIG. 10 is a diagram which shows the image data distribution regions each of which are determined at a random position for each line by the image data distribution region variation means according to the embodiment.

FIG. 11 is a diagram for describing an arrangement example wherein the image data is calculated giving consideration to the quantization error based upon the image data input from the input image memory for providing the image data thus calculated to the recording heads according to the embodiment.

FIG. 12 is a diagram which shows an recording head unit integrally formed of a plurality of recording heads and correction parameter storage means according to the embodiment.

FIG. 13 is a diagram which shows an arrangement example wherein three recording heads are arrayed along the line direction according to the embodiment.

### BEST MODE FOR CARRYING OUT THE INVENTION

Description will be made below regarding an embodiment according to the present invention with reference to the drawings.

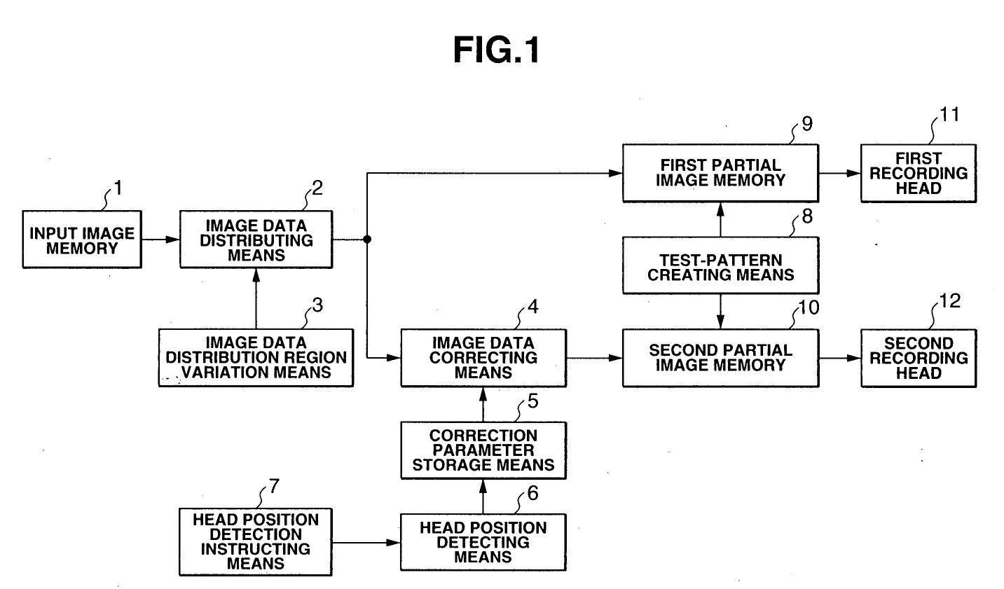

FIG. 1 through FIG. 13 show an embodiment according to the present invention, wherein FIG. 1 is a block diagram which shows a configuration of an image recording device.

As shown in FIG. 1, the image recording device comprises: input image memory 1 for holding image data which is to be printed; image data distributing means 2 for distributing image data read out from the input image memory 1 to a first recording head 11 and a second recording head 12 described later; image data distribution region variation means 3 serving as image data distribution region setting means for varying within a data-overlapped region an image data distribution region for each line as described later, which is a region where the image data related to each pixel is distributed to both of the first recording head 11 and the second recording head 12; head position detecting means 6 for detecting by measuring the phase deviation δ between arrays formed of the recording elements of cyclic arrays provided to the first recording head 11 and the second recording head 12; a head position detection instructing means 7 for instructing the head position detecting means 6 to detect the head position according to an execution timing of detection; correction parameter storage means 5 for storing correction parameters F(δ) corresponding to the phase deviation, wherein in the event that the head position detecting means 6 detect the new phase deviation δ, the correction parameter storage means 5 overwrite the correction parameters F(δ) corresponding to the new phase deviation δ; image data correcting means 4 for correcting the image data distribution region of the partial images distributed from the image data distribution means 2 based upon the correction parameters F(δ) read out from the correction parameter storage means 5; test-pattern creating means 8 for creating a test pattern for examining the arrayed states of the recording elements of the first and second recording heads 11 and 12 if necessary when detection processing is performed by the head position detecting means 6; first partial image memory 9 for storing the partial image data for the first recording head 11 distributed by the image data distributing means 2 or the partial image data for the first recording head 11 created by the test-pattern creating means 8; second partial image memory 10 for storing the partial image data for the second recording head 12 distributed by the image data distributing means 2 and subjected to correction by the image data correcting means 4 or the partial image data for the second recording head 12 created by the test-pattern creating means 8; a first recording head 11 for recording an image on a recording sheet based upon the partial image data stored in the first partial image memory 9; and a second recording head 12 for recording an image on a recording sheet based upon the partial image data stored in the second partial image memory 10.

The image data distribution region variation means 3 sets a data-overlapped region where the image data of each pixel can be distributed to both of the first recording head 11 and the second recording head 12, within a head-overlapped region of the recording heads 11 and 12 arrayed adjacent one to another, and sets an image data distribution region formed of a series of one or more recording elements where the image data of each pixel is actually distributed to both of the first recording head 11 and the second recording head 12, within the data-overlapped region. Note that the position of the image data distribution region along the line is determined so as to be varied for each line.

The image data distributing means 2 distributes image data of each pixel in the image data distribution region set by the image data distribution region variation means 3 to the recording elements with a distribution ratio gradually changed along the line direction.

This realizes smooth connection between the partial images, thereby making the boundaries therebetween less conspicuous even if there is any difference in image density properties between the two recording heads 11 and 12.

The image data correcting means 4 multiplies the data which is to be provided to each recording element by the correction parameter F(δ) stored in the correction parameter storage means 5 so as to correct the image data distributed by the image data distributing means 2.

The head position detecting means 6 may have a configuration wherein the positional relation (interval) between the recording elements is measured using a measuring device so as to detect the phase deviation δ, or may have a configuration wherein the positional relation is measured with respect to the pixels in an image recorded based upon a test pattern created by the test-pattern creating means 8 so as to obtain the phase deviation δ. With the latter configuration, in specifically, the head position detecting means 6 may have a configuration wherein the test pattern printed on a recording sheet is read out with an image scanner or the like, and the positional relation between the pixels is calculated based upon the data thus read out.

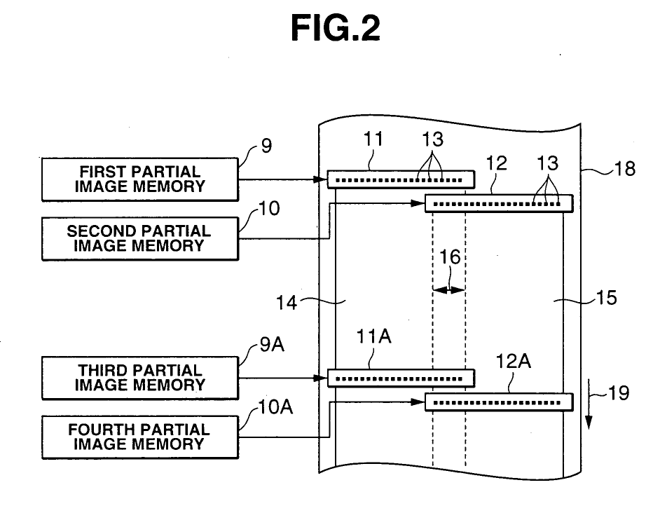

FIG. 2 is a diagram which shows a layout example of the recording heads as to a recording sheet.

In a case of an image recording device for recording a color image, the image recording device records an image using a plurality of color recording heads of K (black), C (cyan), M (magenta), and Y (yellow), for example. Note that FIG. 2 shows two color recording heads of these. That is to say, the recording heads 11 and 12 record an image in K (black), and recording heads 11A and 12A record an image in C (cyan).

Accordingly, the first recording head 11 and the second recording head 12 receive partial image data from the first partial image memory 9 and the second partial image memory 10, respectively. At the same time, the third recording head 11A and the fourth recording head 12A receive partial image data from the third partial image memory 9A and the fourth partial image memory 10A, respectively.

Note that a long roll paper sheet is employed as a recording sheet 18 serving as a recording medium, which is fed in the feeding direction denoted by the reference numeral 19, for example.

Each of the recording heads 11, 12, 11A, and 12A, have a configuration wherein a plurality of recording elements 13 are arrayed in a line with approximately the same interval along the direction orthogonal to the feeding direction denoted by the reference numeral 19, i.e., the line direction.

With the recording heads 11, 12, 11A, and 12A, employing the ink-jet method, each recording element 13 is formed of a nozzle and so forth, for example. Note that various recording elements may be employed corresponding to the recording method.

A recording region 14 recorded by the recording head 11 (or the recording head 11A) and a recording region 15 recorded by the recording head 12 (or the recording head 12A) are arrayed along the line direction with a head-overlapped region 16.

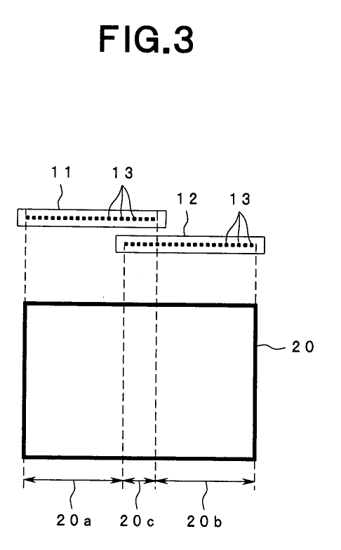

FIG. 3 is a diagram which shows image data distributed by the image data distributing means 2.

Image data 20 read out from the input image memory 1 can be classified into: image data 20a used for recording performed by the first recording head 11 alone; image data 20b used for recording performed by the second recording head 12 alone; and image data 20c used for recording performed by both the first recording head 11 and the second recording head 12.

Accordingly, the first recording head 11 receives the image data 20a and the image data 20c, and the second recording head 12 receives the image data 20b and the image data 20c.

Of the data sets, the common image data 20c is subjected to processing for adjusting the distribution ratio, and correction processing, as described later in detail, following which the common image data 20c is supplied to the recording heads 11 and 12.

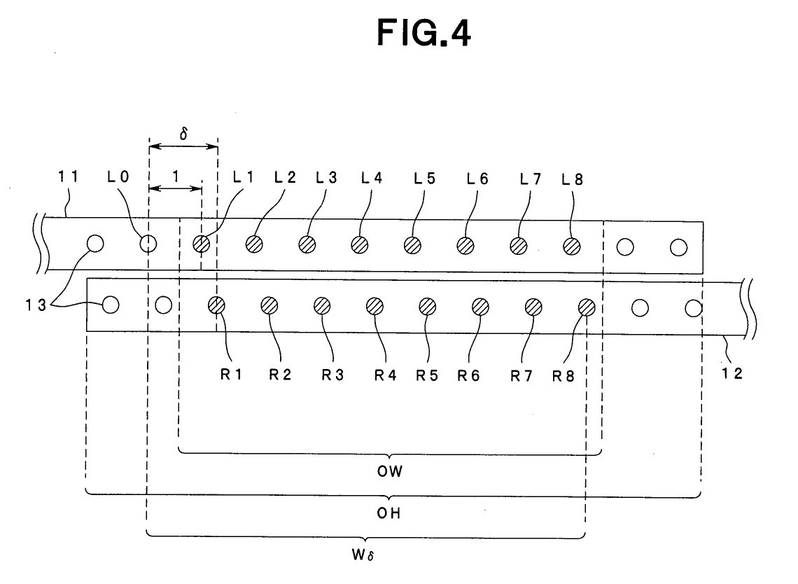

FIG. 4 is a diagram which shows the positional relation of the first recording head and the second recording head in the head-overlapped region.

The first recording head 11 and the second recording head 12 are disposed along the line direction so as to have a head-overlapped region OH.

Furthermore, a data-overlapped region OW with a predetermined range is set in the head-overlapped region OH by the image data distribution region variation means 3. Here, the image data distribution region variation means 3 sets the data-overlapped region OW including: a series of eight recording elements 13 (L1 through L8) of the first recording head 11 positioned on the left side; and a series of eight recording elements 13 (R1 through R8) of the second recording head 12 positioned on the right side, of which positions substantially match the recording elements 13 (L1 through L8), for example.

With such a configuration, in some cases, mounting of the first recording head 11 and the second recording head 12 with generally used precision leads to deviation (phase deviation) in the line direction between the array of the recording elements 13 of the first recording head 11 and the array of the recording elements 13 of the second recording head 12.

FIG. 4 shows generation of a phase deviation δ which is a little larger than an array pitch 1, which assumes the array pitch of the recording elements 13 on the same recording head.

Here, the phase deviation δ is defined, such that in the event that δ is 1, the positions of the recording elements 13 of the first recording head 11 match the positions of the recording elements 13 of the second recording head 12 in the line direction.

Note that the array pitch at which the recording elements 13 are arrayed is 1, and accordingly, an arrangement may be made wherein the phase deviation δ is determined in any range having a width of 1, which includes the integer 1. For example, the phase deviation δ is determined within a range which is greater than 0.5 and is equal to or less than 1.5. It is needless to say that the present invention is not restricted to the range, rather the phase deviation δ may be determined within a range which is greater than 0.3 and is equal to or less than 1.3.

With such a configuration, the first recording head 11 and the second recording head 12 need to be arrayed with the data-overlapped region OW with a certain length (which includes the eight recording elements 13 in the drawing), and accordingly, the first recording head 11 and the second recording head 12 are arrayed with the head-overlapped region OH so as to maintain the data-overlapped region OW, whereby the range of the phase deviation δ can be determined as described above.

Description will be made in detail regarding the phase deviation δ and the positional relation between the first recording head 11 and the second recording head 12.

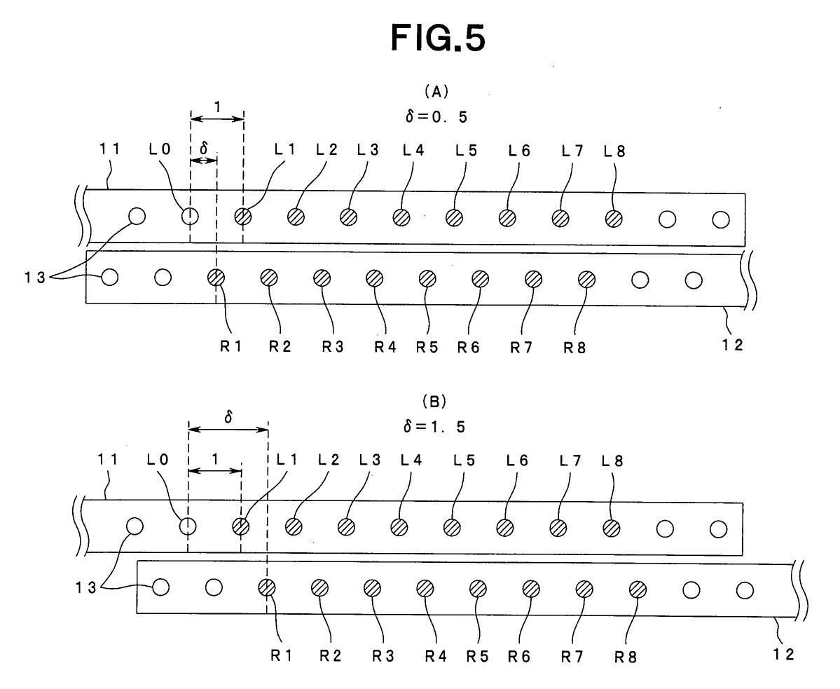

FIG. 5 shows the positional relation between the recording heads mounted with the phase deviation δ of 0.5 and 1.5.

With the recording heads mounted with the phase deviation δ of 0.5, the recording elements 13 of the recording heads 11 and 12 mounted adjacent one to another are deviated along the line direction where the arrays thereof are closer than with the recording heads mounted with the phase deviation δ of 1, as shown in FIG. 5(A).

On the other hand, with the recording heads mounted with the phase deviation δ of 1.5, the recording elements 13 of the recording heads 11 and 12 mounted adjacent one to another are deviated along the line direction where the arrays thereof are farther away than with the recording heads mounted with the phase deviation δ of 1, as shown in FIG. 5(B).

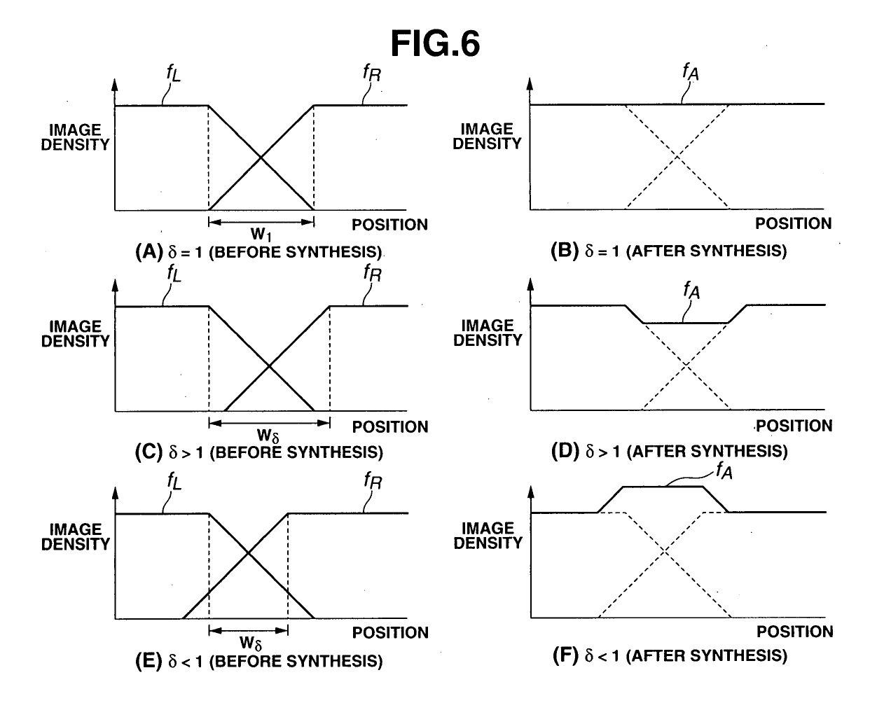

Now, FIG. 6 is a schematic diagram for describing a decrease and increase, due to the phase deviation δ, of the image density properties in the head-overlapped region where the image data is recorded by both the adjacent recording heads.

In the examples shown in FIG. 6, one recording head records image data in the data-overlapped region with a distribution ratio gradually changed such that the image density property thereof is linearly reduced along the direction as the recording head comes closer to the other recording head.

In this case, with the recording heads mounted with δ of 1, as shown in the image density property curve fL on the left side and the image density property curve fR on the right side in FIG. 6(A), the start point in the reduced range of one curve completely matches the end point in the reduced region of the other curve, and accordingly, these image density property curves are synthesized into the image density property curve fA with the same image density in the data-overlapped region being the same as with the region other than the data-overlapped region, as shown in FIG. 6(B).

On the other hand, with the recording heads mounted with δ greater than 1, as shown in the image density property curve fL on the left side and the image density property curve fR on the right side in FIG. 6(C), the start point in the reduced range of one curve and the end point in the reduced region of the other curve are positioned with deviation in the direction where these points are farther away one from another, and accordingly, these image density property curves are synthesized into the image density property curve fA with the image density in the data-overlapped region being smaller than with the region other than the data-overlapped region, as shown in FIG. 6(D). The reason is that in a case of δ greater than 1, the recording heads adjacent one to another are mounted with deviation in the direction where the arrays of the recording elements thereof are farther away one from another, and accordingly, the recording heads record the image data with small ink amount per unit area.

On the other hand, with the recording heads mounted with δ less than 1, as shown in the image density property curve fL on the left side and the image density property curve fR on the right side in FIG. 6(E), the start point in the reduced range of one curve and the end point in the reduced region of the other curve are positioned with deviation in the direction where these points come closer one to another, and accordingly, these image density property curves are synthesized into the image density property curve fA with image density in the data-overlapped region being greater than with the region other than the data-overlapped region, as shown in FIG. 6(F). The reason is that in a case of δ less than 1, the recording heads adjacent one to another are mounted with deviation in the direction where the arrays of the recording elements thereof come closer one to another, and accordingly, the recording heads record the image data with large ink amount per unit area.

The recording device according to the present embodiment has a configuration wherein the image data correcting means 4 performs correction using the correction parameter F(δ) stored in the correction parameter storage means 5 so as to obtain uniform image density properties over the entire region as shown in FIG. 6(B) even in a case of δ other than 1 as shown in FIG. 6(D) and FIG. 6(F).

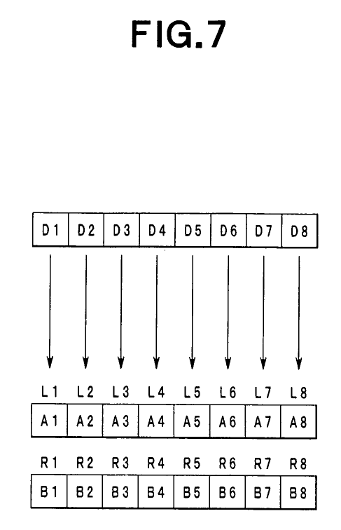

FIG. 7 is a diagram which shows distribution of the image data in the data-overlapped region.

As shown in the drawing, the image data of D1 through D8 which is the image data for the data-overlapped region OW is input to the image data distributing means 2 from the input image memory 1.

Upon the image data distributing means 2 receiving the image data D1 through D8, the image data distributing means 2 distribute the image data of A1 through A8 to the recording elements L1 through L8 included in the data-overlapped region OW of the first recording head 11 positioned on the left side, and distribute the image data of B1 through B8 to the recording elements R1 through R8 included in the data-overlapped region OW of the second recording head 12 positioned on the right side.

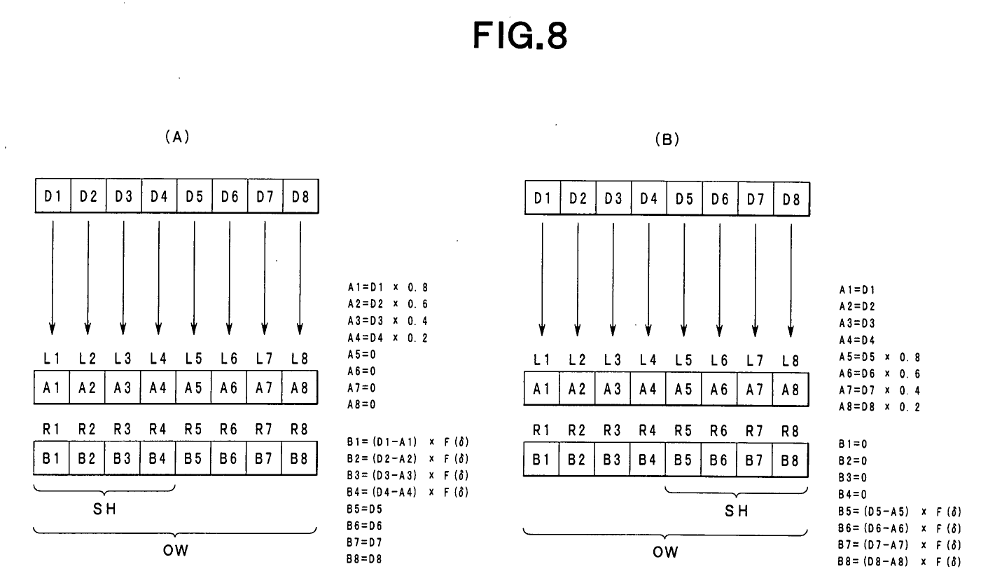

FIG. 8 is a diagram which shows how distribution of the image data is performed corresponding to setting of the image data distribution region.

First, FIG. 8(A) shows image data distribution in a case wherein the image data distribution region SH is set on the left end in the data-overlapped region OW, i.e., in a case wherein the image data distribution region SH is set to a region corresponding to the recording elements L1 through L4, and the recording elements R1 through R4.

In such a case, the image data distributing means 2 distributes image data with a distribution ratio gradually reduced such that the first partial image memory 9 receives the image data of: A1=D1×0.8; A2=D2×0.6; A3=D3×0.4; A4=D4×0.2; and A5=A6=A7=A8=0. The first partial image memory 9 stores the data thus received.

Furthermore, the image data distributing means 2 distribute image data such that the image data correcting means 4 receive the image data of: B1=(D1−A1); B2=(D2−A2); B3=(D3−A3); B4=(D4−A4); B5=D5; B6=D6; B7=D7; and B8=D8.

Subsequently, the image data correcting means 4 performs correction of the data input from the image data distributing means 2 so as to be: B1=(D1−A1)×F(δ); B2=(D2−A2)×F(δ); B3=(D3−A3)×F(δ); and B4=(D4−A4)×F(δ), using the correction parameter F(δ).

The data thus corrected is stored in the second partial image memory 10.

Note that the image data of the region other than the data-overlapped region OW described above is stored either in the first partial image memory 9 or the second partial image memory 10.

Next, FIG. 8(B) shows image data distribution in a case wherein the image data distribution region SH is set on the right end in the data-overlapped region OW, i.e., in a case wherein the image data distribution region SH is set to a region corresponding to the recording elements L5 through L8, and the recording elements R5 through R8.

In such a case, the image data distributing means 2 distributes image data such that the first partial image memory 9 receives the image data of: A1=D1; A2=D2; A3=D3; A4=D4; A5=D5×0.8; A6=D6×0.6; A7=D7×0.4; and A8=D8×0.2.

Furthermore, the image data distributing means 2 distributes image data such that the image data correcting means 4 receives the image data of: B1=0; B2=0; B3=0; B4=0; B5=(D5−A5); B6=(D6−A6); B7=(D7−A7); and B8=(D8−A8).

Subsequently, the image data correcting means 4 performs correction of the data input from the image data distributing means 2 so as to be: B5=(D5−A5)×F(δ); B6=(D6−A6)×F(δ); B7=(D7−A7)×F(δ); and B8=(D8−A8)×F(δ), using the correction parameter F(δ).

Thus, the image data correcting means 4 corrects irregularities in the image density properties which may occur in the image data distribution region SH due to the phase deviation δ using the correction parameter F(δ), thereby improving the uniformity of the image.

While description has been made regarding an arrangement wherein the image data correcting means 4 corrects only one of the image data distributed by the image data recording means 2 using the correction parameter F(δ), the present invention is not restricted to the arrangement, rather, an arrangement may be made wherein the image data correcting means 4 corrects both of the image data distributed by the image data recording means 2, and the image data distributed for the other recording head.

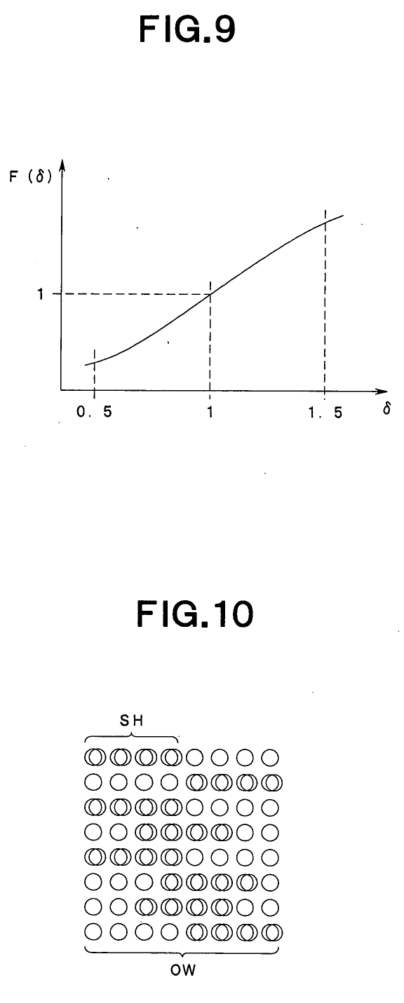

FIG. 9 is a diagram which shows an example of a curve of the correction parameter F(δ) in the form of a function.

As described above with reference to FIG. 6, in a case of δ less than 1 without correction, the image density property is greater than 1 in the image data distribution region SH. On the other hand, in a case of δ greater than 1 without correction, the image density property is less than 1 in the image data distribution region SH. Accordingly, the correction parameter F(δ) is determined in the form of a function which satisfies the conditions of: F(δ=1)=1; F(δ<1)<1; and F(δ>1)>1.

Specifically, in the image density property distribution model constructed on an assumption that the image which is to be recorded is continuous, and image density property therearound can be continuously changed as shown in FIG. 6, both the low image density property in the data-overlapped region shown in FIG. 6(D) and the high image density property in the data-overlapped region shown in FIG. 6(F) are represented by W1/Wδ, wherein the image density property of the flat level region (region other than the data-overlapped region) is normalized by 1. Here, W1 represents the distance between L0 and R8 in a case of δ of 1 as shown in FIG. 4. On the other hand, Wδ represents the distance between L0 and R8 with actual phase deviation δ. Accordingly, with a model as shown in FIG. 6, specifically, the correction parameter F(δ) is represented by F(δ)=Wδ/W1.

In practicality, the image is formed of dots, and the image density property must be determined stepwise, and accordingly, the correction parameter F(δ) is determined in the form of the most suitable function by experiment. FIG. 9 shows an example of such practical correction parameter F(δ) dependent upon δ.

Next, FIG. 10 shows the image data distribution regions SH each of which are determined at a random position for each line by the image data distribution region variation means 3.

As described above, the image data distribution region SH is determined within the data-overlapped region OW. In this case, even in a case of correcting the image data so as to achieve uniformity of the image density properties, the layout of the image data distribution regions SH arrayed at relatively the same position in each data-overlapped region OW for all the lines may lead to conspicuous irregularities around the boundary between the adjacent partial images recorded by the recording heads 11 and 12.

Accordingly, as shown in FIG. 10, the position of the image data distribution region SH is moved within the data-overlapped region OW at random for each line, thereby making the irregularities less conspicuous around the boundary between the adjacent partial images. While it is needless to say that an arrangement according to the present embodiment without such a configuration wherein the position of the image data distribution region SH is moved at random for each line has the same advantage, an arrangement having such a configuration wherein the position of the image data distribution region SH is moved at random for each line has the particularly high advantage.

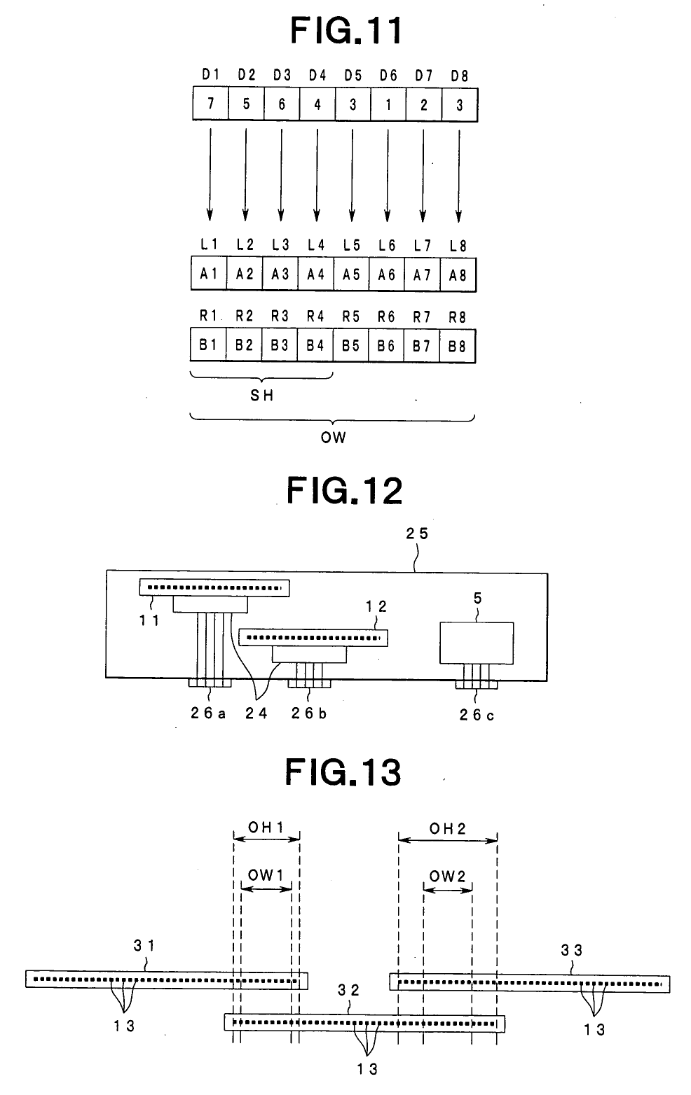

FIG. 11 is a diagram for describing an arrangement example wherein a consideration to the quantization error is given when calculating image data based upon the image data input from the input image memory 1 for providing the image data thus calculated to the recording heads 11 and 12.

The recording elements 13 formed on the recording heads 11 and 12 receive digital data which represents the image density corresponding to the dot position. With a configuration wherein each recording element 13 is formed of a nozzle in the ink-jet method, the image density of each dot is controlled by adjusting the number of drops (drop number), whereby the drop number corresponds to the image density. FIG. 11 shows image data distribution with the recording elements 13 for recording an image with eight gray scales of the drop number of zero through the drop number of seven for each dot.

In this case, as described above with reference to FIG. 6 and so forth, the image density properties of the first and second recording heads 11 and 12 are adjusted such that the image density property of the first recording head 11 is gradually reduced corresponding to the gradually increased image density property of the second recording head 12 in the image data distribution region SH, and are further corrected using the correction parameter so as to smoothly connect the adjacent partial images. Accordingly, even in a case wherein integer image data (quantized values) is read out from the input image memory 1, the image data multiplied by the coefficient is not restricted to an integer. Accordingly, the image data thus obtained leads to the quantization error. Next, description will be made regarding a method wherein such quantization error is not simply rounded off, but is suitably distributed to the other recording elements 13 so as to suppress the irregularities around the boundary due to the quantization error.

Now, let us say that the dada-overlapped region OW is formed of eight recording elements 13, and the image data distribution region SH formed of the four recording elements 13 is set on the left end within the data-overlapped region OW, as shown in FIG. 4 and FIG. 5 as described above.

Furthermore, let us say that the image data input from the input image memory 1 for the data-overlapped region OW is formed of: D1=7; D2=5; D3=6; D4=4; D5=3; D6=1; D7=2 and D8=3, and the correction parameter F(δ)=1.2.

In this case, the image data A1 through A8 for the recording elements L1 through L8 forming the data-overlapped region OW of the first recording head 11, and the image data B1 through B8 for the recording elements R1 through R8 forming the data-overlapped region OW of the second recording head 12, are calculated by the image data distributing means 2 and the image data correcting means 4, as follows.

First, D1 is multiplied by 0.8, and the decimal portion is truncated (i.e., quantized), whereby A1 is calculated.
A1=[D1×0.8]=[7×0.8]=[5.6]=5

Here, the symbol “[ ]” represents a function for creating the maximum integer which is equal to or less than the numerical value.

Next, A1 is subtracted from D1, the result is multiplied by the correction parameter F(δ), and is quantized, whereby B1 is calculated.

$$B 1 = [ ( D 1 - A 1 ) \times F ( δ ) ] = [ ( 7 - 5 ) \times 1.2 ] = [ 2.4 ] = 2$$

Accordingly, 0.4 is truncated value (quantization error) at the time of quantization of B1.

Next, D2 is multiplied by 0.6, and is quantized, whereby A2 is calculated.
A2=[D2×0.6]=[5×0.6]=[3]=3

Next, A2 is subtracted from D2, the result is multiplied by the correction parameter F(δ), and furthermore, the value truncated at the time of quantization of B1 is added to the result, and is quantized, whereby B2 is calculated.

$$B 2 = [ ( D 2 - A 2 ) \times F ( δ ) + 0.4 ] = [ ( 5 - 3 ) \times 1.2 + 0.4 ] = [ 2.8 ] = 2$$

In this case, 0.8 is truncated value (quantization error) at the time of quantization of B2.

Next, D3 is multiplied by 0.4, and is quantized, whereby A3 is calculated.
A3=[D3×0.4]=[6×0.4]=[2.4]=2

Next, A3 is subtracted from D3, the result is multiplied by the correction parameter F(δ), and furthermore, the value truncated at the time of quantization of B2 is added to the result, and is quantized, whereby B3 is calculated.

$$B 3 = [ ( D 3 - A 3 ) \times F ( δ ) + 0.8 ] = [ ( 6 - 2 ) \times 1.2 + 0.8 ] = [ 5.6 ] = 5$$

In this case, 0.6 is truncated value (quantization error) at the time of quantization of B3.

Next, D4 is multiplied by 0.2, and is quantized, whereby A4 is calculated.
A4=[D4×0.2]=[4×0.2]=[0.8]=0

Next, A4 is subtracted from D4, the result is multiplied by the correction parameter F(δ), and furthermore, the value truncated at the time of quantization of B3 is added to the result, and is quantized, whereby B4 is calculated.

$$B 4 = [ ( D 4 - A 4 ) \times F ( δ ) + 0.6 ] = [ ( 4 - 0 ) \times 1.2 + 0.6 ] = [ 5.4 ] = 5$$

In this case, 0.4 is truncated value (quantization error) at the time of quantization of B4.

The other data is distributed to the data-overlapped region other than the image data distribution region SH. In this case, the image data distribution region SH is set on the left end in the data-overlapped region as shown in FIG. 11, and accordingly, all the image data is distributed to the second recording head 12.

That is to say:
A5=0, B5=D5=3
A6=0, B6=D6=1
A7=0, B7=D7=2
A8=0, B8=D8=3

Next, FIG. 12 shows an recording head unit integrated being formed of a plurality of recording heads and correction parameter storage means.

A recording head unit 25 comprises: the first recording head 11; the second recording head 12; detecting means 24 provided to the first and second recording heads 11 and 12 for detecting the state of the first and second recording heads 11 and 12; and the correction parameter storage means 5, which are mounted on a board. Included on the end of the board are: a terminal 26a which allows transmission/reception of signals to/from the first recording head 11 and the detecting means 24 provided to the first recording head 11; a terminal 26b which allows transmission/reception of signals to/from the second recording head 12 and the detecting means 24 provided to the second recording head 12; and a terminal 26c which allows transmission/reception of signals to/from the correction parameter storage means 5.

Specifically, the detecting means 24 comprises: deviation detection sensors; temperature sensors; an acceleration sensor; a power-on detection sensor for detecting power-on operation; a mounting-position detection sensor for detecting adjustment of the mounting position; and so forth.

The mounting-position detection sensor detects adjustment of at least one of the mounting positions of the plurality of recording heads 11 and 12.

The power-on detection sensor detects whether or not the power is supplied to the recording heads 11 and 12. Upon the power-on detection sensor detecting that the power is supplied, the head position detection instructing means 7 instruct the head position detecting means 6 to measure the present phase deviation δ.

Also, an arrangement may be made wherein upon the power-on detection sensor detecting that total operating time reaches a predetermined period of time from the point that the phase deviation δ has been previously measured, which may be measurement at the time of manufacturing, the phase deviation δ is measured, again. Furthermore, an arrangement may be made wherein upon the power-on detection sensor detecting that total non-operating time reaches a predetermined period of time from the point that the phase deviation δ has been previously measured, which may be measurement at the time of manufacturing, the phase deviation δ is measured, again.

The temperature sensors measure the temperatures of the recording heads 11 and 12. It is thought that in the event that the temperature reaches a predetermined temperature, the phase deviation δ changes due to thermal expansion (in the event that the temperature reaches a predetermined high temperature), or due to thermal contraction (in the event that the temperature reaches a predetermined low temperature). Accordingly, in this case, the phase deviation δ is measured, again. Alternately, an arrangement may be made wherein determination is made whether or not the temperature sensors detect rapid change in temperature, i.e., detect rapid change in temperature between the recording heads 11 and 12 within a predetermined period of time, and in the event that determination has been made that the temperature sensors have detected rapid change in temperature, this arrangement measures the phase deviation δ, again.

The deviation detection sensor detects deviation of the recording heads 11 and 12, and it is thought that deviation of the recording heads 11 and 12 with a greater magnitude than with a predetermined deviation leads to change in the phase deviation δ. Accordingly, in this case, this arrangement measures the phase deviation δ, again.

The acceleration sensor detects acceleration applied to the recording heads 11 and 12, and detects vibration during transport of the image recording device by truck or the like. It is thought that in the event that the acceleration sensor has detected acceleration equal to or greater than a predetermined acceleration threshold which causes great vibration (in the event that the image recording device has fallen off from the bed of the truck in transport of the image recording device, for example), the phase deviation δ changes. Accordingly, in this case, this arrangement measures the phase deviation δ, again. Furthermore, an arrangement may be made wherein in the event that the acceleration sensor has detected acceleration which causes vibration applied to the image recording device for a long time, even if the detected acceleration is small, (in the event that the image recording device is transported by truck or the like for a long time, for example), i.e., in the event that the arrangement detects the accumulated acceleration has reached a predetermined value from the point that the phase deviation δ has been previously measured, which may be measurement at the time of manufacturing, this arrangement measures the phase deviation δ, again.

Also, an arrangement may be made wherein the head position detection instructing means 7 instruct the head position detecting means 6 to measure the phase deviation δ, once every predetermined period of time such as: at 9:00 AM every day; on Monday every week; on the first day of every month; or the like.

In the event that the new phase deviation δ is obtained as described above, the new corresponding correction parameter F(δ) is stored in the correction parameter storage means 5, instead of the old one.

This allows the image recording device to detect change in the properties thereof so as to suitably adjust the correction parameter, thereby maintaining high-quality image recording in any situation.

The recording head unit 25 having such a configuration is detachably mounted on the main unit of the image recording device, and the recording head unit 25 mounted on the main unit has functions wherein image data and the detection results detected by the detecting means 24 are transmitted through the terminals 26a, 26b, and 26c.

Each recording head unit having such an integrated configuration is formed of the recording heads arrayed adjacent one to another in the line direction as described above. With such a configuration for multicolor printing as shown in FIG. 2, each recording head unit having such an integrated configuration is formed for each color, for example.

With such a configuration, the correction parameter F(δ) which is property data corresponding to the phase deviation δ between the recording heads arrayed adjacent one to another in the line direction is stored in the correction parameter storage means 5 mounted on the same board beforehand. At the time of replacement of the recording head, the user replaces the recording head unit 25 including the recording head which is to be replaced, thereby having the advantage that the correction parameter is suitably replaced at the same time of mounting. This allows the user to replace the recording head unit 25 without measurement of phase deviation δ.

Next, FIG. 13 is a diagram which shows an arrangement example wherein three recording heads are arrayed along the line direction.

While description has been made regarding an arrangement wherein the two recording heads are arrayed along the line direction, it is needless to say that an arrangement may be made wherein three or more recording heads are arrayed along the line direction in the same way.

With the present arrangement example, a first recording head 31, a second recording head 32, and a third recording head 33, each of which is formed of the recording elements 13 arrayed in the line direction, are arrayed along the line direction at alternating positions along the sheet-feeding direction with small displacement as shown in the drawing.

In this case, the first recording head 31 and the second recording head 32 are arrayed with a head-overlapped region OH1, and the second recording head 32 and the third recording head 33 are arrayed with a head-overlapped region OH2. However, the length of the head-overlapped region OH1 does not equal to the length of the head-overlapped region OH2, unless these recording heads are mounted in particularly high precision.

Even in such a case, the data-overlapped region OW1 determined within the head-overlapped region OH1 is set in the same positional relation as with the data-overlapped region OW2 determined within the head-overlapped region OH2.

Even with such a configuration wherein three or more recording heads are arrayed with two or more head-overlapped regions, each data-overlapped region includes the same number of the recording elements 13, and accordingly, distribution of the image data by the image data distributing means 2, and correction by the image data correcting means 4, are performed using the same processing circuit and the same processing program, thereby enabling computation processing with a simple configuration.

With such a configuration, the image data distributing means 2 distributes the image data read out from the input image memory 1 for the first recording head 31, the second recording head 32, and the third recording head 33.

On the other hand, the image data correcting means 4 corrects at least two sets of the partial image data. With the phase deviation between the first recording head 31 and the second recording head 32 as δ1, and with the phase deviation between the second recording head 32 and the third recording head 33 as δ2, in general, δ1 does not equal to δ2. Accordingly, the correction parameter storage means 5 stores the correction parameters F(δ1) and F(δ2) corresponding to the phase deviation δ1 and δ2, respectively.

While description has been made regarding an arrangement having two-step-processing configuration wherein the output from the image data distributing means 2 is input to the image data correcting means 4 for correction, it is needless to say that an arrangement may be made wherein the two steps of processing are performed by a single circuit at the same time.

With such a configuration for multicolor printing, the boundary between the partial images in Y (yellow) is less conspicuous, and accordingly, the image data correcting means 4 of the circuit for performing processing of images in such color may be omitted. This reduces costs of the image recording device while maintaining acceptable image quality.

While description has been made regarding an arrangement wherein one recording head has: a data-overlapped region including eight recording elements; and a image data distribution region including four recording elements, the present invention is not restricted to the arrangement, rather, the data-overlapped region and the image data distribution region may include more recording elements, or may include less recording elements. The size of the region should be suitably determined giving consideration to the expressible gray scale value of image density for each dot formed by the single recording element, the pitch at which the recording elements are arrayed, and so forth.

While description has been made regarding an arrangement wherein the image data distribution region is positioned at random for each line within the data-overlapped region, in a case of employing recording elements having properties wherein the boundary between the partial images is less conspicuous inherently, an arrangement may be made wherein the image data distribution region is fixed at the same position for each line within the data-overlapped region, or an arrangement may be made wherein the image data distribution region is arrayed at a position regularly changed for each line within the data-overlapped region.

Also, while description has been made regarding an arrangement wherein the decimal portion serving as the quantization error occurring in correcting the image data is distributed to the nearby pixels in the same line so as to reduce irregularities around the boundary due to the quantization error, the present invention is not restricted to the arrangement, rather, an arrangement may be made wherein the decimal portion serving as the quantization error is distributed to the nearby pixels in the line adjacent to the present line, forward or backward, or an arrangement may be made wherein the decimal portion serving as the quantization error is distributed to the nearby pixels in both the lines adjacent to the present line, forward and backward.

While the present invention is particularly effectively applied to a full-line-type recording head formed of a combination of a plurality of recording heads so as to cover a recording width sufficient for the maximum width of the recording medium such as a recording paper sheet or the like, the present invention is also effectively applied to the boundary between the image bands recorded by a serial-scan-type image recording device having a configuration wherein a single recording head or the like is scanned with a smaller recording width in the main-scanning direction, as well as a sub-scanning of the recording sheet in the line direction, and the combination of the main-scanning and the sub-scanning realizes recording of an image with the maximum recording width on a recording medium.

Also, the image recording device according to the present invention preferably includes discharge stabilizing means for the recording head, preliminary auxiliary means, or the like, thereby maintaining stable image density properties in a surer manner. Specific examples of these include: capping means for the recording head; cleaning means; pressing or suctioning means; preliminary heating means formed of an electrothermal-converting member, a heating device, a combination thereof; preliminary discharge means for discharging other than recording.

Furthermore, the kinds and the number of the mounted recording heads according to the present invention are not restricted in particular, rather, an arrangement may be made wherein only a single set of the recording heads is mounted corresponding to a single color ink, or an arrangement may be made wherein plural sets of the recording heads are mounted corresponding to plural kinds of inks each of which has a kind of a color and a density different one from another. The present invention is markedly effectively applied not only to an image recording device having a monochromatic recording mode for recording an image only in a single color such as black or the like, but also to an image recording device having at least one of: a full-color image recording mode by an integrated recording head having a configuration wherein different kinds of inks each of which has a color and a density different one from another are mixed before printing; and a full-color image recording mode by a combination of a plurality of recording heads corresponding to various colors and densities different one from another.

Furthermore, an ink having properties of solidifying at room temperature or less, and melting or liquefying by heating to room temperature or more, may be employed, as well as an ink having properties of serving as a liquid at room temperature. In this case, an arrangement may be made wherein the temperature of the ink is suitably adjusted. The image recording head using such an ink having properties of serving as a solid in a normal situation and liquefying by heating has the advantage of preventing evaporation of the ink. As described above, the present invention can be also applied to an arrangement using an ink having properties of serving as a liquid during ink discharge according to recording signals, and beginning to solidify at the time of reaching the recording medium.

Specific examples of the image recording devices include: a printer used as a image output terminal for an information processing apparatus such as a computer or the like; a photocopier in combination with a scanner or the like; a facsimile having transmission/reception functions; and so forth.

The image recording device according to the present embodiment has the advantage of suppressing irregularities in image density around the boundary between partial images due to phase deviation between arrays of the recording heads arrayed adjacent one to another, each of which is formed of recording elements, thereby obtaining high-quality images.

Note that the present invention is not restricted to the embodiments described above, rather, it is needless to say that various modifications and applications can be made without departing from the spirit and scope of the invention.

### INDUSTRIAL APPLICABILITY

As described above, the image recording device according to the present invention has the advantage of suppressing irregularities in image density around the boundary between partial images due to phase deviation between arrays of the recording heads arrayed adjacent one to another, each of which is formed of recording elements, thereby obtaining high-quality images.

1. An image recording device for recording an image formed of pixels, in units of a line based upon image data, comprising:
a plurality of recording heads formed of a plurality of recording elements cyclically arrayed along the line direction, which are continuously arrayed adjacent one to another in the line direction with head-overlapped regions included in array regions formed of the recording elements arrayed along the line direction;
image data distributing means for distributing the image data to the plurality of recording heads;
image data distribution region setting means for setting in the head-overlapped regions an image data distribution region formed of a series of one or more recording elements by the image data distribution means, the image data distribution region constituting a region where the image data of each pixel, is distributed to both of the two recording heads arrayed adjacent one to another;
correction parameter storage means for storing a correction parameter corresponding to phase deviation between the cyclic arrays each of which are included in the two recording heads arrayed adjacent one to another, for correcting difference, which can be generated when there is the phase deviation, in recording image density properties between the recording elements included in the image data distribution region and the recording elements not included in the image data distribution region; and
image data correcting means for correcting image data for the image data distribution region based upon the correction parameter stored in the correction parameter storage means.

2. An image recording device according to claim 1, wherein the image data distribution region setting means sets a data-overlapped region, wherein the image data of each pixel can be distributed to both of the two recording heads arrayed adjacent one to another, within the head-overlapped region, and sets for each line a position of the image data distribution region so as to be deviated to the line direction within the data-overlapped region.

3. An image recording device according to claim 2, wherein the three or more recording heads are included,
and wherein all the data-overlapped regions included in the two or more head-overlapped regions are determined substantially with the same length along the line direction.

4. An image recording device according to claim 1, wherein the image data distributing means distribute image data with a distribution ratio for each pixel gradually changed from one side to the other side of the array of the recording elements forming the image data distribution region.

5. An image recording device according to claim 1, wherein the plurality of recording heads and the correction parameter storage means form a single unit, which allows the user to replace the recording heads without separating one from another.

6. An image recording device according to claim 1, further including head position detecting means for measuring the positional relation between the recording elements included in the data-overlapped region so as to obtain the phase deviation.

7. An image recording device according to claim 1, further including:
test-pattern creating means for creating a test pattern for measuring the state of the array of the recording elements included in the recording head; and
head position detecting means for measuring the positional relation between the pixels recorded by the recording elements included in the data-overlapped region in an image recorded based upon the test pattern created by the test-pattern creating means so as to obtain the phase deviation.

8. An image recording device according to claim 6, further including head position detection instructing means for instructing the head position detecting means to detect the phase deviation at appropriate timing,
wherein in the event that the new phase deviation is obtained according to instructions from the head position detection instructing means, the correction parameter storage means store the correction parameter corresponding to the new phase deviation.

9. An image recording device according to claim 8, the timing is a timing wherein the user adjusts at least one mounting position of the plurality of recording heads.

10. An image recording device according to claim 8, wherein the timing is a timing wherein non-operating time of the image recording device reaches a predetermined period of time from a point of previous timing when there is the previous timing, or a timing wherein non-operating time of the image recording device accumulated from the point of manufacturing reaches a predetermined period of time when there is not the previous timing.

11. An image recording device according to claim 8, wherein the timing is a timing wherein operating time of the image recording device reaches a predetermined period of time from a point of previous timing when there is the previous timing, or a timing wherein operating time of the image recording device accumulated from the point of manufacturing reaches a predetermined period of time when there is not the previous timing.

12. An image recording device according to claim 8, wherein the timing is once every predetermined time.

13. An image recording device according to claim 8, wherein the timing is a timing wherein the user turns on the power supply of the image recording device.

14. An image recording device according to claim 8, wherein the timing is a timing wherein change in the temperature of the recording head exhibits a predetermined value within a predetermined period of time.

15. An image recording device according to claim 8, wherein the timing is a timing wherein the temperature of the recording head reaches a predetermined temperature.

16. An image recording device according to claim 8, further including a deviation detection sensor mounted on the recording head for detecting deviation of the recording head,
wherein the timing is a timing wherein the deviation detection sensor detects deviation of the recording head equal to or greater than a predetermined value.

17. An image recording device according to claim 8, further including an acceleration sensor mounted on the recording head for detecting at least whether or not acceleration equal to or greater than a predetermined value is applied to the recording head,
wherein the timing is a timing wherein the acceleration sensor detects acceleration equal to or greater than the predetermined value.

18. An image recording device according to claim 8, further including an acceleration sensor mounted on the recording head for detecting acceleration applied to the recording head,
wherein the timing is a timing wherein the accumulated value detected by the acceleration sensor reaches a predetermined value from the point of previous measurement when there is the previous timing, or a timing wherein the accumulated value detected by the acceleration sensor reaches a predetermined value from the point of manufacturing.

19. An image recording device according to claim 1, wherein the image data correcting means corrects a quantization error occurred in correction of image data of at least one pixel in the image data distribution region when correcting image data of other pixels in the neighborhood.

20. An image recording device according to claim 7, further including head position detection instructing means for instructing the head position detecting means to detect the phase deviation at appropriate timing,
wherein in the event that the new phase deviation is obtained according to instructions from the head position detection instructing means, the correction parameter storage means store the correction parameter corresponding to the new phase deviation.

21. An image recording device according to claim 20, the timing is a timing wherein the user adjusts at least one mounting position of the plurality of recording heads.

22. An image recording device according to claim 20, wherein the timing is a timing wherein non-operating time of the image recording device reaches a predetermined period of time from a point of previous timing when there is the previous timing, or a timing wherein non-operating time of the image recording device accumulated from the point of manufacturing reaches a predetermined period of time when there is not the previous timing.

23. An image recording device according to claim 20, wherein the timing is a timing wherein operating time of the image recording device reaches a predetermined period of time from a point of previous timing when there is the previous timing, or a timing wherein operating time of the image recording device accumulated from the point of manufacturing reaches a predetermined period of time when there is not the previous timing.

24. An image recording device according to claim 20, wherein the timing is once every predetermined time.

25. An image recording device according to claim 20, wherein the timing is a timing wherein the user turns on the power supply of the image recording device.

26. An image recording device according to claim 20, wherein the timing is a timing wherein change in the temperature of the recording head exhibits a predetermined value within a predetermined period of time.

27. An image recording device according to claim 20, wherein the timing is a timing wherein the temperature of the recording head reaches a predetermined temperature.

28. An image recording device according to claim 20, further including a deviation detection sensor mounted on the recording head for detecting deviation of the recording head,
wherein the timing is a timing wherein the deviation detection sensor detects deviation of the recording head equal to or greater than a predetermined value.

29. An image recording device according to claim 20, further including an acceleration sensor mounted on the recording head for detecting at least whether or not acceleration equal to or greater than a predetermined value is applied to the recording head,
wherein the timing is a timing wherein the acceleration sensor detects acceleration equal to or greater than the predetermined value.

30. An image recording device according to claim 20, further including an acceleration sensor mounted on the recording head for detecting acceleration applied to the recording head,
wherein the timing is a timing wherein the accumulated value detected by the acceleration sensor reaches a predetermined value from the point of previous measurement when there is the previous timing, or a timing wherein the accumulated value detected by the acceleration sensor reaches a predetermined value from the point of manufacturing.
